(19) United States
(12) Patent Application Publication
(10) Pub. No.: US 2003/0178462 A1
(43) Pub. Date: Sep. 25, 2003

(54) Film wrapper cutting device

(76) Inventor: Johnson Huang, Taipei (TW)

Correspondence Address: Johnson Huang, 5 Fl., No. 755, MIN TZU E. ROAD, P.O. Box 24-108, TAIPEI, TW

(21) Appl. No.: 10/100,291

(22) Filed: Mar. 19, 2002

(51) Int. Cl. B26F 3/02

(52) U.S. Cl. 225/89; 225/43; 225/56

(57) ABSTRACT

A film wrap cutting device includes an elongate case base and a cover base pivotally connected at their ends. The case base defines a receiving space for receiving a film wrap. Both ends of the receiving space are provided with elastic clamping seats. Lateral edges of the case base and the cover base are provided with inter-engageable guide slots and posts to allow the case base and cover base to open or close within a determined angle. A toothed cutter having an outwardly curved central portion projects downwardly from a front edge of the cover base. An elastic press piece is insertably provided at a front end of the cutter, with a clamping projecting piece provided behind. The case base is provided with opposed recesses in corresponding positions. The recess opposed to the clamping projecting piece is insertably provided with another elastic press piece. The film wrap clamped by the push clamping seats in the case base can be pulled out between the case base and the cover base. By pressing the case base and the cover base, the cutter is caused to displace downwardly to cut off a section of the film wrap. The elasticity provided by the elastic press pieces in combination with the engagement of the guide slots and posts causes the case base and the cover base to automatically open, while the clamping projecting piece behind allows the film wrap to be stretched to a certain length for pulling outwardly from a central notch.

### BACKGROUND OF THE INVENTION

(a) Field of the Invention

The present invention relates generally to a film wrap cutting device, and more particularly to a film wrap cutting device that is convenient to use and assemble.

(b) Description of the Prior Art

People care more and more about sanitation and health. In the past, leftover food was covered by newspapers or a screen and the like. Nowadays, people use film wrap to wrap up leftover food. In general, film wraps are packed in paper packs with a cutter thereon. However, the cutter is exposed on the outside and may easily hurt the user. Besides, the pack may become deformed. Furthermore, improper pulling of the film wrap may result in breaking or uneven edge of the film wrap. Moreover, when it is desired to use the film wrap again, it is necessary to open the pack to pull out a section of the film wrap. As can be seen from the above, the conventional film wrap is not convenient to use. There has been developed a kind of film wrap cutting device having a plastic casing for receiving and cutting a film wrap. Although such a device can eliminate the danger that the exposed cutter might hurt the user, drawing of the film wrap from the device and assembly of the device is not very convenient.

### SUMMARY OF THE INVENTION

A primary object of the present invention is to provide a film wrap cutting device. According to this object, a film wrap cutting device includes an elongate case base and a cover base pivotally connected at their ends. The case base defines a receiving space for receiving a film wrap. Both ends of the receiving space are provided with elastic clamping seats. Lateral edges of the case base and the cover base are provided with inter-engageable guide slots and posts to allow the case base and cover base to open or close within a determined angle. A toothed cutter having an outwardly curved central portion projects downwardly from a front edge of the cover base. An elastic press piece is insertably provided at a front end of the cutter, with a clamping projecting piece provided behind. The case base is provided with opposed recesses in corresponding positions. The recess opposed to the clamping projecting piece is insertably provided with another elastic press piece. The film wrap clamped by the push clamping seats in the case base can be pulled out between the case base and the cover base. By pressing the case base and the cover base, the cutter is caused to displace downwardly to cut off a section of the film wrap. The elasticity provided by the elastic press pieces in combination with the engagement of the guide slots and posts causes the case base and the cover base to automatically open, while the clamping projecting piece behind allows the film wrap to be stretched to a certain length for pulling outwardly from a central notch.

Another object of the present invention is to provide a film wrap cutting device in which elastic press pieces are disposed in grooves of the case base and the front edge of the cover base provide an elasticity to clamp and press the film wrap in position and to enable the case base and cover base to automatically open. Besides, they are easy to assemble.

### BRIEF DESCRIPTION OF THE DRAWINGS

The foregoing and other features and advantages of the present invention will be more clearly understood from the following detailed description and the accompanying drawings, in which,

FIG. 1 is a perspective view of a preferred embodiment of the present invention;

FIG. 2 is a perspective exploded view of the preferred embodiment;

FIG. 3 is a side view of the preferred embodiment;

FIG. 4 is a perspective view of the preferred embodiment in an open state; and

FIG. 5 is a side sectional schematic view of the preferred embodiment in a closed state.

### DETAILED DESCRIPTION OF THE PREFERRED EMBODIMENT

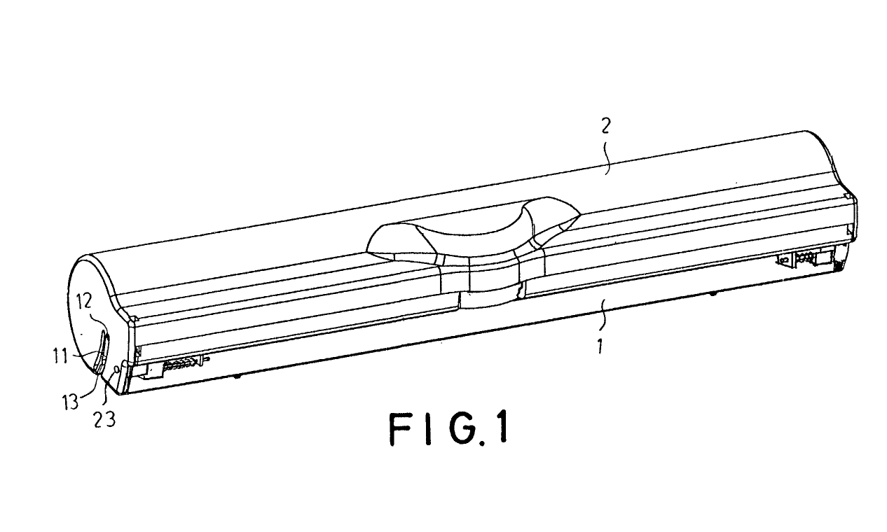

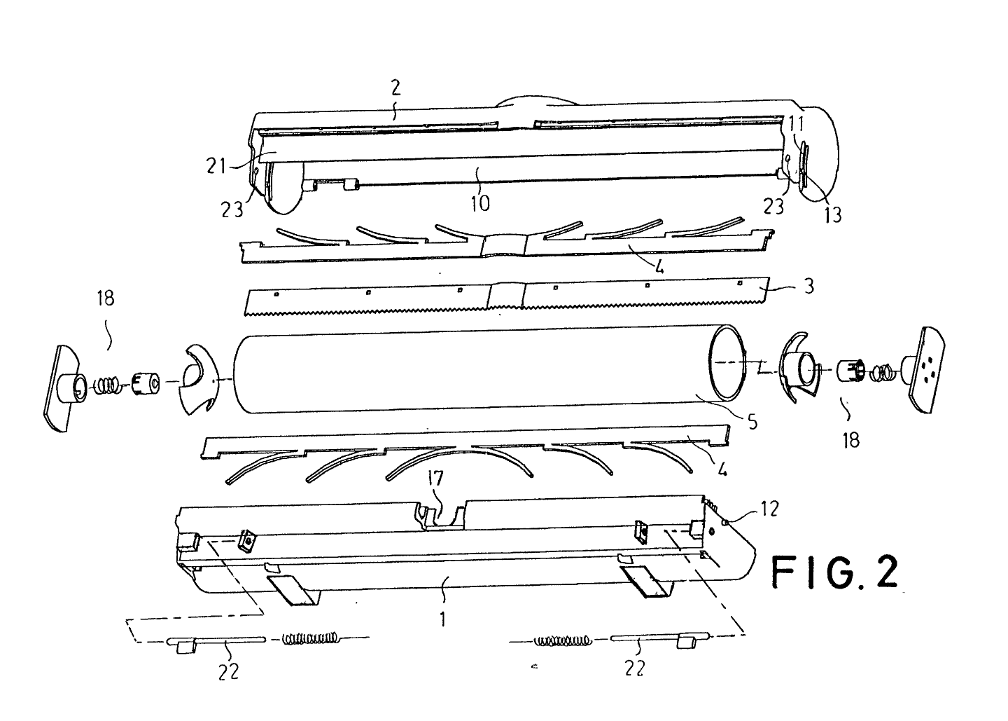

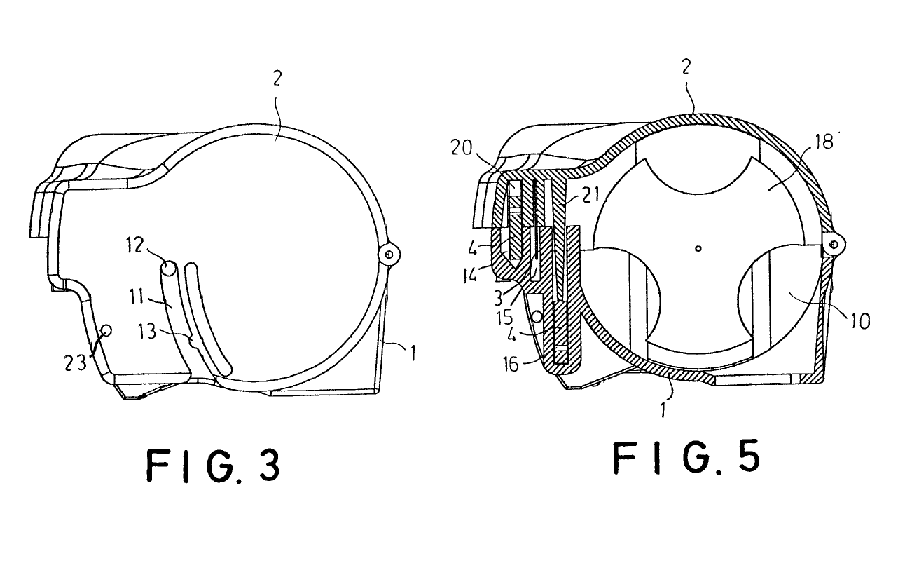

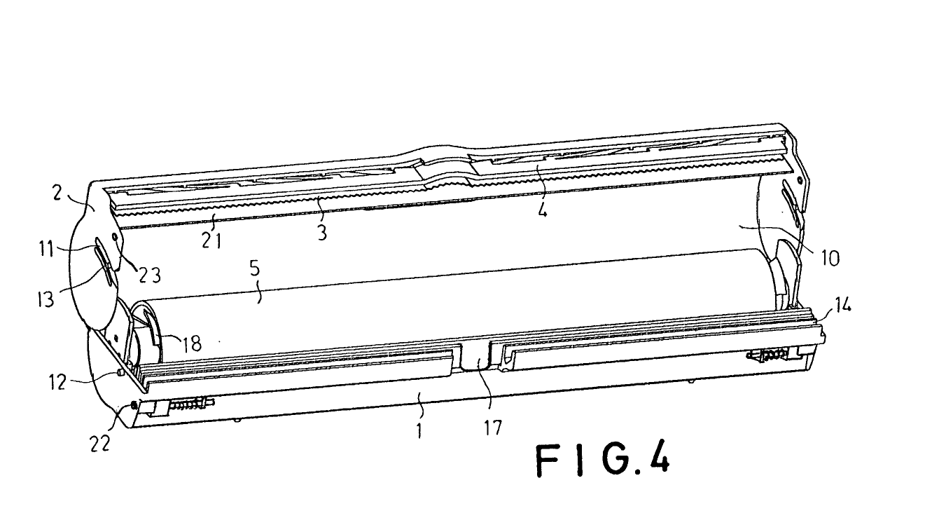

With reference to FIGS. 1 to 5, the present invention essentially includes a case base, a cover base 2, a cutter 3, and elastic press pieces 4. The case base 1 is an elongate body having an interior defining a film receiving space 10 for receiving a film wrap 5. If necessary, the case base 1 can be adhesive-backed or provided with a securing seat so that it can be secured firmly on a wall surface or a planar surface. Both ends of the receiving space 10 are provided with a respective elastic clamping seat 18 adapted to push and clamp the film wrap 5 from both ends. The cover base 2 is provided to cover the case base 1. The case base 1 and the cover base 2 are pivotally connected at distal ends thereof. Lateral edges of the cover base 2 and the case base 1 are provided with opposed guide slots 11 and posts 12, respectively, so that they can open with respect to each other about a determined angle. The guide slots 11 may be configured to have an opening that is checked by a stop edge 13 and communicated with the edge to facilitate opening of the cover base 2 to allow access to the film wrap 5. In addition, a front edge of the cover base 2 is provided with the above-mentioned cutter 3 that extends downwardly. The cutter 3 is toothed and has an outwardly curved central portion. A groove 20 in front of the cutter 3 has the projecting plastic elastic press piece 4 insertably provided therein. Clamping projecting pieces 21 are provided at the rear. The front edge of the case base 1 is provided with opposed recesses 14, 15, 16 in corresponding positions Besides, a second elastic press piece 4 is insertably provided in the recess 16 opposed to the clamping projecting piece 21, and the center of the front edge of the case body 1 forms a notch 17. Furthermore, both sides of the bottom portion of the case base 1 may be provided with pins 22 (preferably resilient) that project towards the two sides, and the cover case 2 is correspondingly provided with opposed retaining through holes 23.

In actual use, the user may exert a little force to cause the posts 12 to slip past the stop edges 13 of the guide slots 11 to permit the cover base 2 to be turned open to allow replacement or placement of the film wrap into the case base 1. The elastic clamping seat 18 causes the film wrap 5 to be held in a suspended manner to thereby prevent generation of friction with inner sides of the cover base 2 or case base 1 during rotation thereof One end of the film wrap 5 is pulled out from the front edge of the case base 1, and a force is exerted in the opposite direction to cause the posts 12 to slip past the stop edges 13 again and slide into the guide slots 11. Due to the stop edges 13, the case base 1 and the cover base 2 may open or close along the guide slots 11 about a determined angle. When use of the film wrap 5 is intended, the front end of the film wrap 5 is pulled to a desired length, and the cover base 2 is pressed downwardly so that the cover base 2 utilizes the pivots at the distal ends thereof in tandem with the engagement of the guide slots 11 and the posts 12 to perform rotation, whereby the cutter 3 at the front end cuts off a section of the film wrap 5. At this time, the elastic press piece 4 in front of the cutter 3 prevents the cutter 3 from being exposed on the outside, which may hurt the user, and clamp the film wrap 5 in place to prevent the circumstance that when the section of the film wrap is being cut, an excessive pulling force would cause the cut to be uneven. In addition, the clamping projecting piece 21 behind the cutter 3 works in conjunction with the other elastic press piece 4 to clamp the film wrap 5 and sink into the recess 16 to thereby stretch the film wrap 5 outwardly. In this way, after a section of the film wrap 5 is cut off, a relatively long head section of the film wrap 5 remains exposed on the outside. The curved central portion of the cutter 3 enables the central portion of the cut film wrap to project from the its surface to facilitate the user to pull out a desired section of the film wrap with his/her fingers in the next operation. When the user releases the cover base 2 after cutting, the elastic press pieces 4 will, due to their compressive elasticity, automatically keep the case base 1 and the cover base 2 open until the posts 12 are stopped by the stop edges 13. At this point, the head section of the cut film wrap 5 will be clearly exposed on the notch 17 at the center of the front edge of the case base 1 to facilitate the user to grip the head section of the film wrap 5 when the next cutting is necessary. After use or wrapping, the cover base 2 can be pressed to cause it to close with the case base 1. The pins 22 are then turned so that they pass through the retaining through holes 23 to secure the case base 1 and the cover base 2 in position. Besides, the overall size of the present invention can be kept compact and dust entry can be prevented. When it is desired to use the present invention again, the above-mentioned procedures can be taken in a reverse manner to unfasten the case base 1 and the cover base 2.

Although the present invention has been illustrated and described with reference to the preferred embodiment thereof, it should be understood that it is in no way limited to the details of such embodiment but is capable of numerous modifications within the scope of the appended claims.

What is claimed is:

1. A film wrap cutting device, comprising:
a case base having an elongate casing and an interior defining a film receiving space for receiving a film wrap; and
a cover base for covering said case base and connecting with said case base at distal ends,
wherein both ends of said film receiving space are provided with elastic clamping seats, respectively, adapted to push and clamp the film wrap, a toothed cutter having an outwardly curved central portion projecting I 10 downwardly from a front edge of said cover base, a groove in front of said cutter having a projecting plastic elastic press piece insertably provided therein, a clamping projecting piece being provided at the rear, a front edge of said case base being provided with opposed recesses in corresponding positions of said projecting plastic elastic press piece, clamping projecting piece and cutter, a second elastic press piece being insertably disposed in said opposed recess of clamping protecting piece, said front edge of said case base having a central portion forming a notch.

2. A film wrap cutting device as claimed in claim 1, wherein laterals edges of said cover base and said case base are respectively provided with guide slots or posts in opposite positions, whereby said cover base and said case base may open or close within a determined angle, said guide slots being formed with an opening communicated with edges thereof with a stop edge disposed therebetween whereby said cover base is liftable to allow access to the film wrap.

3. A film wrap cutting device as claimed in claim 1, wherein one of said case base and said cover base is provided with projectable pins in suitable positions, and one of said case base and said cover base is provided with retaining through holes in corresponding positions to allow coupling of said case base and said cover base by inserting said pins into said retaining through holes.
